(19) United States
(12) Patent Application Publication
(10) Pub. No.: US 2002/0093417 A1
(43) Pub. Date: Jul. 18, 2002

(54) Electrical resistor with thermal voltage prevention

(76) Inventor: Reiner Gross, Munchen (DE)

Correspondence Address: LERNER AND GREENBERG, P.A., Post Office Box 2480, Hollywood, FL, 33022-2480, US

(21) Appl. No.: 10/007,390

(22) Filed: Oct. 22, 2001

(30) Foreign Application Priority Data
Oct. 20, 2000 (DE) 100 52 178.9

(51) Int. Cl. H01C 1/012

(52) U.S. Cl. 338/309; 338/276

(57) ABSTRACT

An electrical resistor including a resistance zone and connections that are connected to electrically conductive supply leads. The supply leads are designed as busbars that run parallel to one another and are also intermeshed in one another or coaxial and between which is arranged an electrically insulating layer that is a good thermal conductor. The construction including the resistor and the supply leads is surrounded by a layer that is a good thermal conductor.

### BACKGROUND OF THE INVENTION

### FIELD OF THE INVENTION

The invention relates to an electrical resistor, and in particular to a resistor for current measurements that includes a resistance zone and connections. The connections are connected to electrically conductive power supply leads that are designed as busbars.

Published German patent application DE 196 38 288 A1 discloses a resistor for detecting the current flowing in multiconductor systems, whose connections are connected to supply leads designed as busbars, an electrically insulating layer that is a good thermal conductor being arranged between the resistor and the busbars.

Published German patent application DE 30 04 802 A1 describes a fixed resistor which can be inserted into printed circuits in a simple manner, in particular by placement machines. The fixed resistor includes a resistive layer which is arranged on a substrate and having soldering connections, lying parallel to one another, that are likewise arranged on the substrate.

Published German patent application DE 1 081 571 B discloses an electrical component, in particular a capacitor, which, for protection against moisture, is encapsulated with a composition including epoxy resin formed in a mold. For protection against adhesion in the mold, the molding is surrounded with a sheet of metal or metalized plastic.

Published German patent application DE 196 28 471 A1 discloses a resistor that is wound onto a ceramic substrate. This resistor, in order to increase the operational reliability, is arranged in a ceramic housing and the latter is arranged in a metal housing.

Electrical resistors, in particular embodiments whose resistance zone is composed of metal alloys, are primarily used as current/voltage converters for current measurements. Their resistance varies in the mΩ range. By using chopper-stabilized operational amplifiers, the measurement voltage that can be tapped off across them can be defined in the region around 100 μV.

Measurements on metal alloy resistors, for example, on copper/manganin/copper resistors, which have a thermal voltage between their connections, yield a thermal voltage coefficient of about 6 μV/° C.

A temperature difference of 1° C. between the connections of the resistor generates a thermal voltage of about 6 μV, which is superposed undesirably on the measurement voltage. In the case of a measurement voltage of 100 μV, this means that the measurement result is corrupted by 6%.

In the case of high currents flowing through the resistor, the connections of the resistor heat up, for example, also as a result of contact resistances at the contact areas that lead to further electrical structural parts. That leads to a temperature gradient at the resistor if different quantities of heat are generated at its connections for constructional reasons, if the dissipation of heat varies, or if the resistor is heated or cooled asymmetrically as a result of the radiation of heat or cold from adjacent structural parts.

### SUMMARY OF THE INVENTION

It is accordingly an object of the invention to provide an electrical resistor which overcomes the above-mentioned disadvantages of the prior art apparatus of this general type. In particular, it is an object of the invention to configure an electrical resistor in such a way that thermal voltages cannot occur or are significantly reduced, with the result that their effects do not impair the measurement result or only impair it to an insignificant extent.

With the foregoing and other objects in view there is provided, in accordance with the invention, an electrical resistor that includes: a resistance zone; connections; electrically conductive power supply leads designed as busbars; and an electrically insulating layer configured between the power supply leads. The electrically insulating layer is a good thermal conductor. The power supply leads are connected to the connections. The power supply leads run parallel to one another. The power supply leads have an end remote from the resistance zone, and the ends of the power supply leads are designed as connection contacts.

In accordance with an added feature of the invention, there is provided, another electrically insulating layer that is a good thermal conductor and a construction including the resistance zone and the power supply leads except for the connection contacts. The other insulating layer surrounds the construction.

In accordance with an additional feature of the invention, there is provided, a conductive layer that is a good electrical and thermal conductor. The conductive layer surrounds the construction and the other insulating layer.

In accordance with an another feature of the invention, the power supply leads are intermeshed in one another.

In accordance with a further feature of the invention, the power supply leads are of coaxial design.

In accordance with a further added feature of the invention, the power supply leads are configured in a manner selected from the group consisting of being stacked and being rolled up like a wound capacitor.

In accordance with a concomitant feature of the invention, there is provided, a protective barrier made of thermally nonconductive material. The protective barrier is configured between adjacent structural parts that produce heat or cold.

The electrical resistor is provided with separate supply leads which are embodied in such a way that a thermal coupling or a thermal short circuit is produced between them, which puts the two connections of the resistor at the same temperature level. In addition, a layer made of electrically insulating material that is a good thermal conductor is placed around the construction that includes the resistor, the connections and the supply leads. These measures prevent the production of a thermal voltage across the resistor.

Radiation sources acting externally on the resistor are shielded by a barrier made of thermally nonconductive material which is arranged between resistor and radiation source.

Other features which are considered as characteristic for the invention are set forth in the appended claims.

Although the invention is illustrated and described herein as embodied in an electrical resistor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A shows a first exemplary embodiment with supply leads running parallel to one another;

FIG. 1B shows a cross section of the first exemplary embodiment;

FIG. 2A shows a second exemplary embodiment with supply leads running parallel to one another;

FIG. 2B shows a cross section of the second exemplary embodiment;

FIG. 3A shows a third exemplary embodiment with parallel supply leads that are intermeshed in one another;

FIG. 3B shows a cross section of the third exemplary embodiment;

FIG. 4A shows a fourth exemplary embodiment with supply leads that run coaxially; and

FIG. 4B shows a cross section of the fourth exemplary embodiment.

### DESCRIPTION OF THE PREFERRED EMBODIMENTS

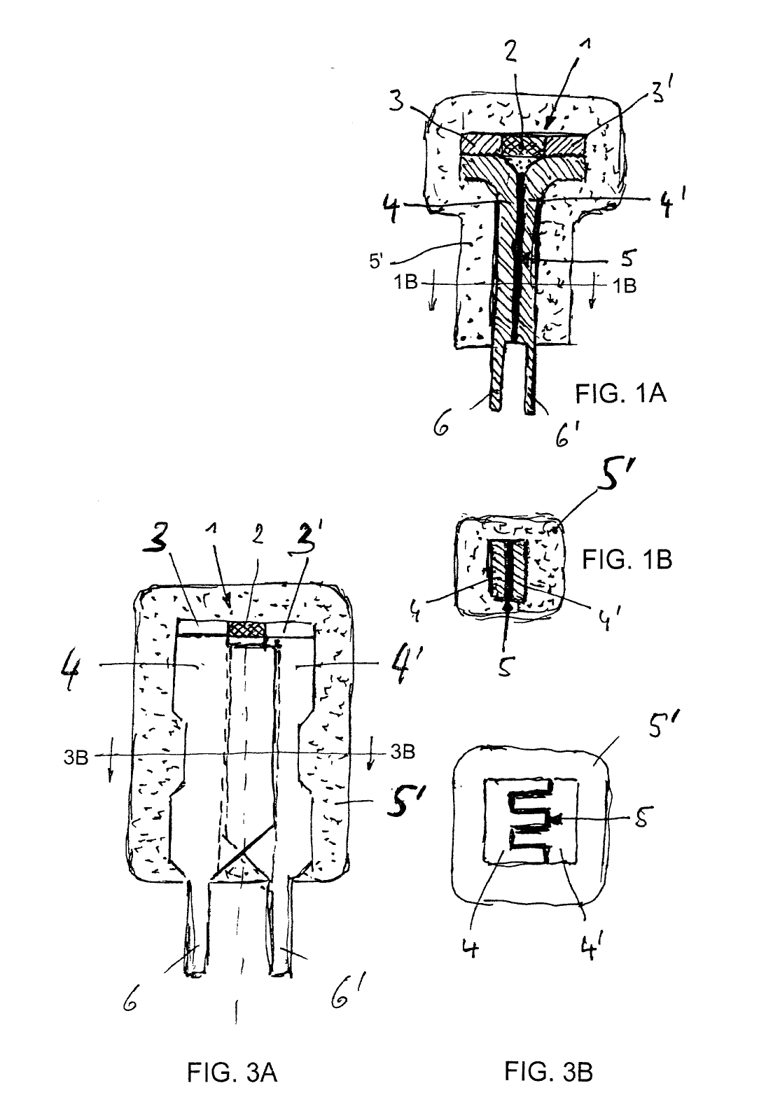

Referring now to the figures of the drawing in detail and first, particularly, to FIG. 1A thereof, there is shown a longitudinal section through an electrical resistor 1 having a resistance zone 2 for example, made of manganin (metal alloy). Connections 3 and 3′, for example. made of copper are connected to the resistance zone 2. Power supply leads 4 and 4′, for example, likewise made of copper, are designed as busbars which run parallel to one another and between which is arranged an electrically insulating layer 5 that is a good thermal conductor. The power supply leads 4 and 4′ are connected, for example soldered, to the connections 3, 3′. The dimensioning of the power supply leads 4 and 4′ should be chosen such that they correspond in width and thickness at least to the dimensions of the connections 3, 3′, but are advantageously as large as possible in order to ensure a good thermal coupling between the two connections 3, 3′. The power supply leads 4, 4′, at the end remote from the resistor 1, can be designed as connection contacts 6, 6′, for example, as plug-in or soldering contacts.

The construction including the resistor and the power supply leads, with the exception of the plug-in or soldering contacts, is surrounded with a layer 5′made of electrically nonconductive material that is a good thermal conductor.

FIG. 1B shows a cross section taken through the line 1B-1B in FIG. 1A in the central region of the power supply leads.

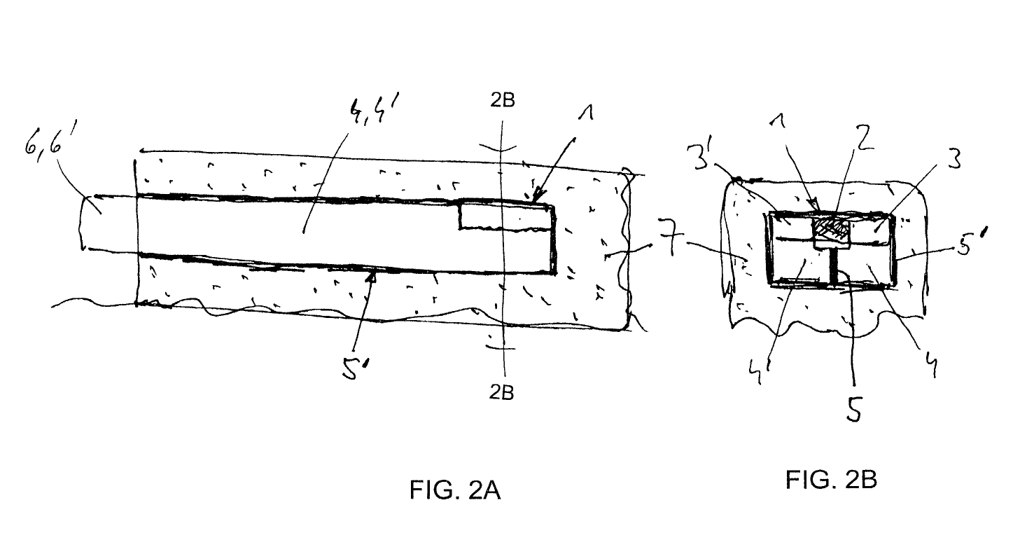

FIG. 2A shows, as a second exemplary embodiment, a longitudinal section through an electrical resistor 1 of the type shown in FIG. 1A. The second embodiment uses the same reference symbols as in FIG. 1A, however, in the second embodiment, the difference is that the resistance zone 2, with its connections 3, 3′ and the power supply leads 4, 4′ running parallel to one another, are designed as a block and are surrounded by an electrically nonconductive layer 5′ that is a good thermal conductor. This electrically insulated block is embedded in a housing or housing part 7 that is a good thermal conductor, for example made of aluminum.

FIG. 2B shows a cross section taken through the line 2B-2B in FIG. 2A in the region of the resistor 1.

FIG. 3A shows, as a third exemplary embodiment, a longitudinal section through an electrical resistor of the type shown in FIG. 1A, and uses the same reference symbols as in FIG. 1A. The difference in the third exemplary embodiment is that the busbars (power supply leads 4, 4′) , which run parallel to one another and which are isolated from one another by an electrically insulating layer 5 that is a good thermal conductor, are intermeshed in one another for the sake of better temperature equalization. This is better illustrated by the cross section shown in FIG. 3B that was taken through the line 3B-3B in FIG. 3A.

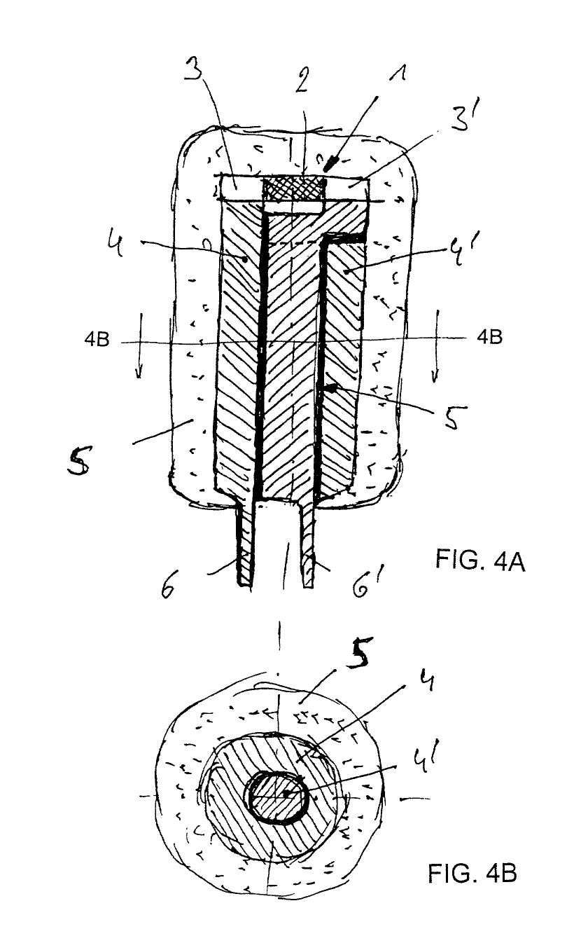

FIG. 4A shows, as a fourth exemplary embodiment, a longitudinal section through an electrical resistor of the type shown in FIG. 1A, and uses the same reference symbols as in FIG. 1A. The difference in the fourth exemplary embodiment is that the busbars (power supply leads 4, 4′), which run parallel to one another and which are isolated from one another by an electrically insulating layer 5 that is a good thermal conductor, are routed coaxially for the sake of better temperature equalization. This is better illustrated by the cross section shown in FIG. 4B that was taken through the line 4B-4B in FIG. 4A.

The supply leads 4, 4′can also be embodied, in a manner that is not illustrated, as busbars which are stacked or rolled up in the manner of a wound capacitor and isolated from one another by electrically insulating layer(s) 5 that is (are) good thermal conductor(s).

The layer 5′in FIGS. 1A, 1B, 3A, 3B, 4A and 4B is a good thermal conductor but electrically nonconductive. If this layer is also electrically conductive -7-, then it is necessary to provide between the construction including resistor 1, its connections 2, 2′ and the power supply leads 4, 4′running parallel to one another, and the electrically conductive layer 7, an electrically nonconductive layer 5′ that is a good thermal conductor, as is illustrated in the second exemplary embodiment according to FIG. 2A.

With the embodiments illustrated by way of example in FIGS. 1A to 4B, electrical resistors are obtained in which a disturbing thermal voltage that corrupts a measurement result is prevented.

If an electrical resistor is heated or cooled asymmetrically as a result of thermal radiation from adjacent structural parts that produce heat or cold, then a protective barrier made of thermally nonconductive material is arranged, in a manner that is not illustrated, between the electrical resistor and said heat-producing structural parts.

I claim:

1. An electrical resistor, comprising:
a resistance zone;
connections;
electrically conductive power supply leads designed as busbars; and
an electrically insulating layer configured between said power supply leads;
said electrically insulating layer being a good thermal conductor;
said power supply leads connected to said connections; said power supply leads running parallel to one another;
said power supply leads have ends remote from said resistance zone; and
said ends of said power supply leads being designed as connection contacts.

2. The electrical resistor according to claim 1, comprising:
another electrically insulating layer that is a good thermal conductor; and
a construction including said resistance zone and said power supply leads except for said connection contacts;
said other insulating layer surrounding said construction.

3. The electrical resistor according to claim 2, comprising:
a conductive layer that is a good electrical and thermal conductor;
said conductive layer surrounding said construction and said other insulating layer.

4. The electrical resistor according to claim 1, wherein said power supply leads are intermeshed in one another.

5. The electrical resistor according to claim 1, wherein said power supply leads are of coaxial design.

6. The electrical resistor according to claim 1, wherein said power supply leads are configured in a manner selected from the group consisting of being stacked and being rolled up like a wound capacitor.

7. The electrical resistor according to claim 1, comprising:
a protective barrier made of a thermally nonconductive material;
said protective barrier configured between adjacent structural parts that produce heat or cold.
